(19) United States
(12) Patent Application Publication
(10) Pub. No.: US 2016/0040840 A1
(43) Pub. Date: Feb. 11, 2016

(54) LIGHTING FIXTURE OF THE WALL WASHER TYPE

(71) Applicant: IGUZZINI ILLUMINAZIONE S.P.A., Recanati (IT)

(72) Inventor: Massimo Gattari, Potenza Picena (IT)

(21) Appl. No.: 14/780,474

(22) PCT Filed: Mar. 26, 2014
(86) PCT No.: PCT/IB2014/060161

§ 371 Date: Sep. 25, 2015

(30) Foreign Application Priority Data
Mar. 26, 2013 (IT) FI2013A000065

(51) Int. Cl. F21S 8/00; F21V 5/00; F21V 13/04; F21V 5/08; F21V 7/00; F21V 23/00; F21V 7/22

(52) U.S. Cl. CPC F21S 8/033; F21V 23/009; F21V 5/002; F21V 5/008; F21V 7/22; F21V 5/08; F21V 7/0025; F21V 13/04; F21Y 2101/02

(57) ABSTRACT

Lighting fixture of the wall washer type adapted to light a wall in an effective and as uniform as possible manner, without producing light spots on the wall itself and minimizing possible glares to users attending the lighted rooms. The lighting fixture according to the present invention introduces a structure comprising point-like lighting sources (16), preferably consisting of LEDs, and two reflecting elements (11, 14) adapted to direct the produced lighting beam towards a wall and minimize the amount of said light beam emitted in the direction of the user of the lighted room.

### CROSS REFERENCE TO RELATED APPLICATIONS

The present application claims priority to PCT International Application No. PCT/IB2014/060161 filed on Mar. 26, 2014, which application claims priority to Italian Patent Application No. FI2013A000065 filed Mar. 26, 2013, the entirety of the disclosures of which are expressly incorporated herein by reference.

### STATEMENT RE: FEDERALLY SPONSORED RESEARCH/DEVELOPMENT

Not Applicable.

### FIELD OF THE INVENTION

The present invention relates to the technical field of lighting devices and in particular to the technical field of LED lighting devices of the so-called wall washer type.

BACKGROUND OF THE ART

In relatively recent times, lighting techniques have been subjected to major changes, also due to the availability of lighting sources, such as LEDs, which offer a flexibility of control and use unknown until recently.

One of these lighting techniques is called wall washing, and consists in lighting a wall with uniform lighting, almost as to “wash” it with a jet of light.

This type of lighting is particularly used by architects and lighting system designers when a uniform lighting is required over large surfaces, for example to emphasize the surface structure of a wall or its colors. It is used in the field of contemporary architecture, in lighting historic and precious buildings, in museums and galleries, and in the field of the so-called landscape lighting in general.

The wall washing technique is further employed to light the walls of a room so that the room itself appears wider, brighter and with higher ceilings, or even to highlight objects arranged on the lighted wall.

People's visual perception develops mainly horizontally and not vertically, for a relation that has been estimated at about 1.75:1. This means that we pay more attention to the objects that are arranged in front of or around us, with respect to objects that are above or below us. Therefore, the vertical walls are an element that constantly occupies our sight and our focus, thus their lighting has a significant effect on the perception of the room by an observer highlighting surfaces, finishings, objects and contours, and virtually adding volume to the lighted space.

Therefore, it the object of a lighting fixture of the wall washer type to light a wall in an effective and as uniform as possible manner, without producing light spots on the wall itself and minimizing possible glares to users attending the lighted rooms.

The lighting fixture according to the present invention allows to achieve the aforementioned object by introducing an innovative structure comprising point-like lighting sources, preferably consisting of LEDs, and two reflecting elements adapted to direct the lighting towards a wall and minimize the amount of the light beam emitted in the direction of the user of the lighted room.

### BRIEF DESCRIPTION OF THE FIGURES

FIG. 1 shows a sectional view of a preferred embodiment of the lighting fixture according to the present invention.

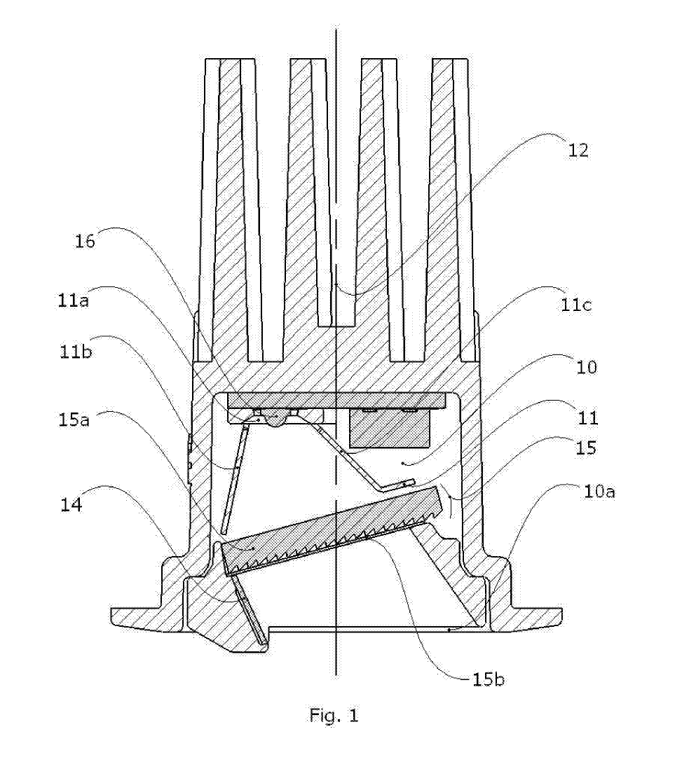

FIG. 2 shows a sectional view of a preferred embodiment of the lighting fixture according to the present invention where the inclination angles of the walls of first reflector, second reflector and optical refractor are depicted.

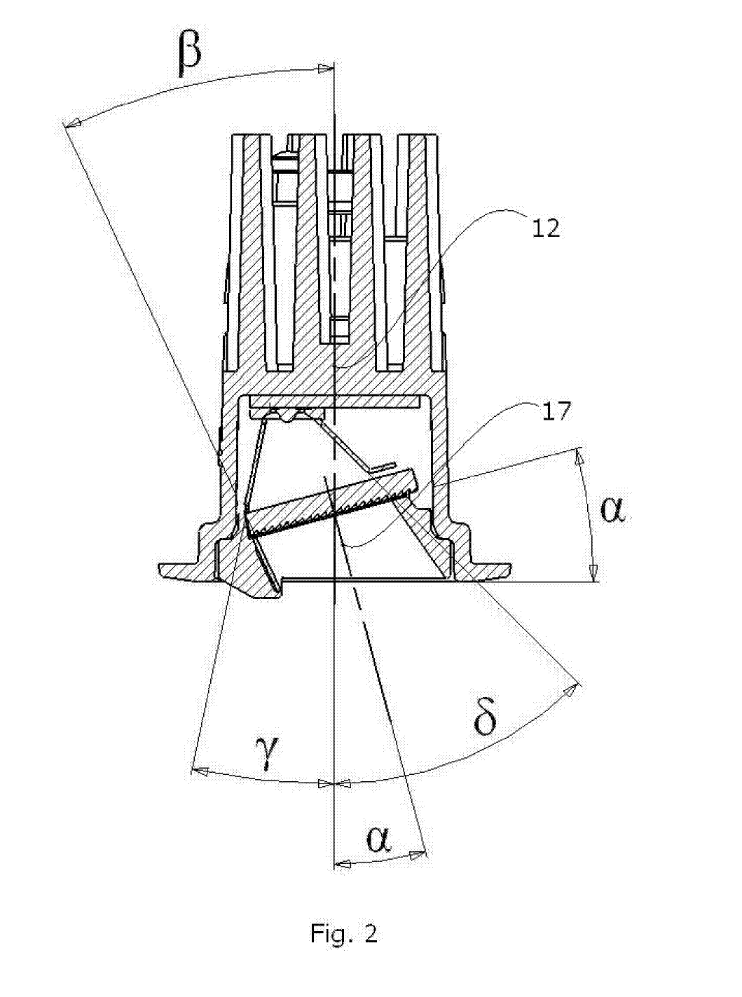

### SUMMARY OF THE INVENTION

A lighting fixture of the wall washer type adapted to light a wall in an effective and as uniform as possible manner, without producing light spots on the wall itself and minimizing possible glares to users attending the lighted rooms.

The lighting fixture according to the present invention introduces a structure comprising point-like lighting sources, preferably consisting of LEDs, and two reflecting elements adapted to direct the produced lighting beam towards a wall and minimize the amount of the light beam emitted in the direction of the user of the lighted room.

### DETAILED DESCRIPTION OF THE INVENTION

With reference to the accompanying drawings, the lighting fixture according to the present invention comprises a lighting body arranged in a compartment 10 provided with an opening 10a, said lighting body comprising:

a first reflector 11, arranged in an offset position with respect to the middle axis 12 of said lighting fixture, and in turn comprising: an upper part 11a, adapted to accommodate lighting sources, a lateral surface comprising a first flank 11b and a second flank 11c, said first flank 11b having an inclination angle γ with respect to said middle axis 12, which is smaller than the corresponding inclination angle δ of said second flank 11c with respect to said middle axis 12, and an opening 13 lying on a plane inclined, with respect to the plane containing said opening 10a, at a certain angle α. Said upper part 11a, adapted to accommodate point-like lighting sources such as LEDs, can be advantageously implemented so as to maximize the light reflection and electrically insulate the driving circuit of said LEDs, for example by using high reflectivity plastics;

a second reflector, arranged beneath said first reflector 11 and comprising a surface 14, arranged on the same side of said first flank 11b and lying on a plane inclined at a certain angle β with respect to the axis 12 of said lighting body;

an optical refracting element 15 arranged between said first reflector 11 and said second reflector and having substantially the same inclination as said opening 13.

Said first reflector 11 is adapted to generate a lighting beam having the middle axis 17 inclined, with respect to the axis 12 of said lighting body, approximately at an angle equal to a, said second reflector is adapted to redirect the light emission beam towards the surface to be lighted, arranged in a substantially orthogonal direction with respect to the plane comprising the opening 10a of said compartment 10, while said optical refractor is adapted to mix the transmitted light emission and contribute to direct it towards the wall to be lighted.

In a preferred embodiment of the present invention, said optical refractor comprises two diffusing screens, the first screen 15a, of the micro-prism or micro-lined type is adapted to direct the light towards the wall to be lighted while the second screen 15b, preferably of the diffusing or glazed type, is adapted to uniform the light emission so as to prevent light spots and/or strips on the wall to be lighted and complete the light mixing effect which prevents the direct view of the light sources, thus increasing the users' visual comfort.

In a second preferred embodiment of the present invention, said second reflector is characterized in that it has the lower edge projecting from the edge of the lighting fixture and from said opening 10a of said compartment 10, so as to further orient the lighting beam for allowing said wall to be lighted to be flush-lighted without leaving grey areas close to the intersection zone between the wall itself and the plane comprising the opening 10a of said compartment 10.

In its simplest construction, said second reflector consists of a rectangular panel having a reflecting surface appropriately treated. Both said first 11 and second reflectors can be made of appropriate reflecting materials, such as anodized aluminum, possibly superficially treated by sand-blasting or other machining processes adapted to provide for a plurality of relieves, such as to promote the mixing of the reflected light beam. Other usable materials include films and/or reflecting plastics, e.g. of the type charged with titanium dioxide.

In a further preferred embodiment of the lighting fixture according to the present invention, said angle α is selected with a value from 0° to 45°, preferably with a value of about 15°+/−5°; said angle β is selected with a value from 15° to 45°, preferably with a value of about 25°+/−5°; said angle γ is selected with a value from 0° to 45°, preferably with a value of about 12°+/−5°; said angle δ is selected with a value from 25° to 60°, preferably with a value of about 45° +/−5°. These values allow to obtain the optimal illumination of the wall to be lighted, without grey areas close to the intersection zone between the wall itself and the plane comprising the opening 10a of said compartment 10.

The operation of the lighting fixture according to the present invention benefits from the presence of the described structure, comprising a double reflector and an intermediate diffusing screen, to provide uniform lighting, diffused and extended over the whole surface of the wall to be lighted including the zone close to the intersection of said wall with the plane comprising the opening 10a of the compartment 10 of said lighting fixture.

Indeed, said first reflector carries out a first deviation of the total light beam emitted by the point-like lighting sources, orienting it towards the wall to be lighted approximately at an angle a, while said second reflector carries out a further deviation of the beam transmitted by said intermediate diffusing screen so as to light also the areas of said wall which are closer to said lighting fixture.

The appropriate selection of the value of the aforementioned angles α, β, γ and δ and of the possible protrusion of the edge of said second reflector from the edge of the lighting fixture according to the present invention allows the quality and direction of the produced light beam to be optimized.

The lighting fixture according to the present invention may be provided with a plurality of said compartments 10, each comprising a lighting body as that previously described.

1. A lighting fixture comprising a compartment, provided with an opening, and adapted to accommodate a lighting body comprising: a first reflector, arranged in an offset position with respect to the middle axis of said lighting fixture, and in turn comprising an upper part, adapted to accommodate lighting sources, a lateral surface comprising a first flank and a second flank, said first flank having an inclination angle γ with respect to said middle axis, which is smaller than the corresponding inclination angle δ of said second flank with respect to said middle axis, and an opening lying on a plane, inclined with respect to the plane containing said opening by a certain angle α; a second reflector, arranged beneath said first reflector and comprising a surface, arranged on the same side as said first flank and lying on a plane inclined by a certain angle β with respect to the axis of said lighting body; an optical refracting element arranged between said first reflector and said second reflector and substantially having the same inclination as said opening.

2. The lighting fixture according to claim 1, wherein said lighting sources comprise LEDs.

3. The lighting fixture according to claim 2, wherein said upper part of said first reflector is further adapted to maximize the light reflection and to electrically insulate the driving circuit of said LEDs.

4. The lighting fixture according to claim 1, wherein said optical refractor comprises two diffusing screens, the first screen, of the micro-prism or micro-lined type being adapted to direct the light towards the wall to be lighted while the second screen, of the diffusing or glazed type, being adapted to uniform the light emission so as to prevent light spots and/or strips on the wall to be lighted and complete the light mixing effect which prevents the direct view of the light sources.

5. The lighting fixture according to claim 1, wherein said second reflector is implemented by a rectangular panel having reflecting surface.

6. The lighting fixture according to claim 1, wherein said first and said second reflector are made of anodized aluminum, superficially treated by sanding or other machining processes adapted to implement a plurality of relieves, such as to promote the mixing of the reflected light beam, or made of reflecting plastic or reflecting film.

7. The lighting fixture according to claim 1, wherein said second reflector has the lower edge projecting from the edge of the lighting fixture and from said opening of said compartment, so as to further orient the lighting beam for allowing said wall to be lighted to be flush-lighted without leaving grey areas close to the intersection zone between the wall itself and the plane comprising opening of said compartment.

8. The lighting fixture according to claim 1, wherein said angle α is selected with a value in the range between 5° and 25°; said angle β is selected with a value in the range between 15° and 35°; said angle γ is selected with a value in the range between 5° and 20°; said angle δ is selected with a value in the range between 25° and 65°.

9. The lighting fixture according to claim 8, wherein said angle α is selected with a value approximately equal to about 15°+/−5°; said angle β is selected with a value approximately equal to about 25°+/−5°; said angle γ is selected with a value approximately equal to about 12°+/−5′; said angle δ is selected with a value approximately equal to about 45°+/−5°.

10. The lighting fixture according to claim 1, comprising a plurality of said compartments and of said lighting bodies.
